(19) United States
(12) Patent Application Publication
(10) Pub. No.: US 2020/0364173 A1
(43) Pub. Date: Nov. 19, 2020

(54) UNIVERSAL BRIDGE CONTROLLER FOR MACHINE LANGUAGE INTERPRETIVE COLLABORATIVE ROBOT AND MACHINE INTERFACE

(71) Applicant: All Axis Robotics, LLC, Dallas, TX (US)

(72) Inventors: Gary Kuzmin, Plano, TX (US); David Perkowski, Plano, TX (US); Cristian Almendariz, Mansfield, TX (US); Alejandro Siller, Irving, TX (US); Rebecca Molnar, Irving, TX (US)

(21) Appl. No.: 16/560,967

(22) Filed: Sep. 4, 2019

Related U.S. Application Data
(60) Provisional application No. 62/726,777, filed on Sep. 4, 2018.

(51) Int. Cl. G06F 13/40; G06F 13/42; G05B 19/4155

(52) U.S. Cl. CPC G06F 13/4027; G06F 13/4221; G06F 13/4282; G05B 2219/33099; G06F 2213/0024; G06F 2213/0018; G06F 2213/0042; G05B 19/4155

(57) ABSTRACT

In accordance with the present invention, systems and methods for creating a universal bridge controller interface that provides a unified and common set of commands between a host machine and a peripheral machine or robot. The universal bridge controller may simplify the ability to integrate, synchronize, and coordinate the control and operation of various machines. This may be beneficial to companies wishing to implement cost saving automation techniques to a variety of machines built by different manufacturers. The advantage of this approach is that it may allow for a single hardwired link to be created between the machine and the bridge controller allowing for robot integration over a factory network, creating a high level of portability of robots between machine work cells.

### BACKGROUND

### Technical Field

This invention relates in general to the field of workpiece fabrication, and more particularly, but not by way of limitation, to systems and methods to facilitate the use of collaborative robots in metal fabrication.

### Background

Throughout history, the goal of manufacturers, regardless of the industry, has always been to find improved means to reduce production cycle time, increase employee output, improve manufacturing efficiency, and improve customer on-time delivery and quality levels while maintaining and improving profitability. Nonetheless, these goals are only achievable to those entrepreneurs willing to make capital investments in their manufacturing operations. Now, more than ever, as the labor shortages spread throughout industrialized nations, impacting productivity and raising wages, automated implementation has become increasingly important in manufacturing.

A major step to improving efficiencies in the metal fabrication process was the introduction of the Computer Numerical Controls (CNC) machines. These machines were developed to replicate the skill of a master craftsman machinist in a machine to help improve manufacturing efficiency. As we know today, that investment effort resulted in a milling machine (generically known as a CNC machine today) that was capable of reliably building complex fabricated parts with extreme precision and repeatability over manual machining methods. These CNC machines could simultaneously duplicate on a larger scale what one master craftsman could do. CNC machines could store programs that were once only in the mind of a machinist and those programs could be accessed by multiple people and machines.

These new CNC machines required a new skillset of programmers to program the machines. The machinists often became both the programmer of the machine and the operator of the machine. The machine operators were required to tend the machine to load and unload parts as well as check the parts for compliance to tolerances. The result of using CNC machines versus the previous manufacturing methods resulted in a dramatic reduction of normal production times.

Over the next 50 years, as machine building methods and programs to operate CNC machines evolved, the introduction of computer-aided manufacturing (CAM) and digital motor controls improved the ability to achieve far more complex and accurate machining. The conversion to digital controls eventually resulted in the ability to program computer devices with multiple nodes to control the machine tooling process, resulting in rapid advances in shop productivity by automating the highly technical and labor intensive processes and eventually leading to the introduction of multiple levels of automation, including browser based automation, such as, for example, U.S. Pat. No. 7,480,709, which is hereby incorporated by reference.

Industrial robots, again because of the development of digital controls, were also developed during this same time period. Industrial robots were the first automated systems designed to mimic and replace humans for monotonous and mundane manufacturing tasks. Industrial robot advantages have been especially proficient at cutting costs, increasing productivity, improving quality, and taking over dangerous or harmful tasks such as moving or positioning heavy parts and casting, welding, and bending.

Deployments of industrial robots require significant financial and human resource investments. They also require hiring more skilled staff as the programming of the industrial robots is neither intuitive nor similar to CAM programming of a CNC machine. One example of an attempt to overcome this difficulty is set forth in U.S. Pat. No. 9,448,553, which is hereby incorporated by reference. In addition, industrial robots have multiple potential safety hazards requiring more safeguards to be considered during both programming and deployment. Recently, a new generation of robots, known as collaborative robots, has become available to the marketplace. The introduction of collaborative robots is changing all the preconceived thoughts about the ease to introduce robotics into both high-volume, low-mix and high-mix, low-volume applications. A benefit of collaborative robots is their ability to work safely alongside humans. Therefore, human-robot collaboration is the new wanted characteristic for robots. Some collaborative robots can be taught very easily by demonstration, instead of requiring a deep knowledge in programming. Thus, they can be implemented very easily and brought online fast, since no complicated setup (e.g., the installation of protective fences or guards around the robot) is needed.

Large robots, because of their weight and the torque that they generate, are often bolted directly to the factory floor in order to ensure they hold alignment. While bolting to the floor ensures alignment, the robot is fixed in its location and cannot be moved or redeployed. To raise smaller robotic arms to the correct height for tending a CNC machine, smaller collaborative robots are often mounted onto a raised hardware platform or pedestal. These smaller industrial collaborative robots are often bolted onto a pedestal that, because of the amount of torque that they generate, is also bolted to the floor of the factory to ensure alignment. However, similar to the larger robots, these robots would also be in a fixed location and unable to be moved or redeployed.

Machinists need the ability to mount a collaborative robot onto a pedestal assembly in such a manner that allows a machine operator to move the robot out of the spindle access port to perform either machine tool maintenance on the machine or check the accuracy of a part. When done, the pedestal needs to be returned exactly to its original position in front of the machine maintaining registrations between the robot and the machine and the robot and the matrix tray. To address the mobility issue, pedestals having wheels thereon have been introduced. However, the location of a collaborative robot must be fixed in order to maintain an exact relationship between the robotic arm and the CNC machine. Feet have been added to the bottom of the pedestal to raise the wheels off the ground to prevent the pedestal from rolling while the robotic arm is in use.

In addition to being mobile, the pedestal must maintain a fixed position (x-y-z axes) during production in order to insure the robotic arm's ability to accurately pick up raw material and place it into a machine and then remove a finished part and place it in a matrix tray, repeatedly. To secure the pedestal from tipping over or being bumped out of alignment, L-brackets have been added to the bottom of pedestals so that the assembly may be bolted to the machine shop floor. Features are now available that allow robots to be quickly released from their mounts and moved to a new location while keeping their last known alignment.

When a manufacturer builds a piece of equipment where controlled motion or movement is involved or required, the manufacturer must provide and create set of instructions directing how the machine components move. This set of instructions is called a controller. The controller is essentially a highly customized computer. Controllers in machines control the axis and duration of movement and then wait for instruction sets to determine the next move. These controllers are embedded into the machine's electronic and mechanical architecture. The machine is often referred to as primary or host controller as it is often a permanently installed anchor machine.

The controller requires input from a variety of sources. One source may be from sensors located and placed within the machine. Another set of inputs may be from software code/programming. Often the two will work in conjunction with each other and one of the reasons it is embedded in the machine architecture. An example of a CNC machine having integrated sensors is set forth in U.S. Pat. No. 10,055,512, which is hereby incorporated by reference.

There are very few standards established for controller software design as each manufacturer's approach is unique to the product that they are building. Often it reflects a particular manufacturing advantage over another manufacturer's approach to solving a similar problem. Many manufacturers of either 2D or 3D machine control systems often use proprietary formats in the on-machine computers or controllers. Access to the controller feature is strictly regulated by the machine manufacturers. This is one of the reasons why many users prefer to stay with one brand of machine as it reduces the number of different systems an operator must learn. Controllers for machines vary in their complexity depending on the complexity of the machine. The more features and movement in the machine, the more complex the controller.

Many manufacturers, when developing custom controllers, try to develop and provide a GUI in an effort to increase ease-of-use, improve operational efficiency, and bring more control to the shop floor when programming the machine. But these GUI controls are limited in that they required manual input and for complex jobs may be labor intensive. Additionally, the GUI and controls are specific to that particular machine. Even across a single manufacturer's product line, the GUI control is specific to that machine and may not be translatable to their other machines. However, in all of these cases, the manufacturers do not allow links to be interfaced with third party equipment.

To resolve this problem, CAM (Computer Aided Manufacturing) incorporates a variety of new tools and features designed to simplify the programming process. Software packages were automated to program offline the required manufacturing path desired by the user. But since the two packages (manufacturer controller and manufacturer third party offline programmer) speak different software languages, a third piece of software was used to provide translation services between the two packages. This is what is known as a post processor. However, the problem remains that access to the controller to remotely control on-off-run-idle-wait operational states is not accessible through the third-party CAM programs. One such example is set forth in U.S. Pat. No. 8,347,264, which is hereby incorporated by reference.

To overcome this problem, typically what occurs is that integrators attempt to connect third-party equipment to a host machine. To do this, they will hardwire the sensors and I/O directly from the host machine to the third-party machine. For each functionality, there is a communication link (often a wire) to connect the machine to the function. This is where the on-off-run-idle-wait operational state control is achieved. This configuration requires that the platforms be either permanent or semi-permanent in their installation with respect to each other.

The disadvantage is that these integrators lose portability and flexibility within the automation process/platform. For instance, in the example of collaborative robots, the collaborative robots have both digital and analogue input/outputs in their controller. The collective input/outputs of the host machine (often a CNC machine) has to be hardwired and mapped to the appropriate communications channel in the collaborative robot controller. This means that a separate and direct communications link from the peripheral to the collaborative robot has to be established for each functional operation. This means that for a machine tending operation, the door operation, part vices, air solenoids for chip control, vision detection systems, force sensors, part grippers, safety devices and emergency-stops (e-stops) and G-code synchronization must all be hardwired directly from the machine to the robot. This is a minimum of nine independent wired link connections that have to be established. There are two problems with this approach. First, it restricts portability of the collaborative robot. If the robot faults or needs to be moved, all the hard wires need to be removed and re-linked in order to replace the collaborative robot. In addition, the replacement collaborative robot needs to be manually re-programmed before it can be put into service. The second problem is that the collaborative robot controller has a limited number of I/O ports available. For example, some robots utilize an automation cable, such as a Lumberg RKMV 8-354, which has eight wires for eight different functions inside the cable. Other I/O ports include RS232, Ethernet (master), Modbus TCP/RTU (master & slave). Oftentimes, communications takes place via one or more COM connections, one or more HDMI connections, one or more LAN connections, and/or one or more USB connections (2.0 and/or 3.0). These limits may include actual number of ports and the available voltage of these ports. For example, some ports specify a maximum drive current of 300 mA per channel and if the load exceeds 300 mA, a relay is required. Modbus is a communication protocol developed by Modicon systems. In simple terms, it is a method used for transmitting information over serial lines between electronic devices. The device requesting the information is called the Modbus Master and the devices supplying information are Modbus Slaves. In a standard Modbus network, there is one Master and up to 247 Slaves, each with a unique Slave Address from 1 to 247. The Master can also write information to the Slaves.

Currently, there is not an existing solution to facilitate control of a collaborative robot. Currently, there are no universal bridge controllers on the market that connect a host machine with a collaborative robot or third-party machines or allow for multiple auxiliary machines to be connected to coordinate and synchronize the work function of a single or multiple host machine to a computer network.

### SUMMARY OF THE INVENTION

In accordance with the present invention, systems and methods for creating a universal bridge controller interface that provides a unified and common set of commands and graphical user interface (GUI) between a manufacturer's host machine (and their variable input/output (I/O) signals) and a secondary or auxiliary powered machine or robot. The universal bridge controller may simplify the ability of third-party manufacturers to integrate, synchronize, and coordinate the control and operation of various machines. This may be beneficial to companies wishing to implement cost saving automation techniques to a variety of machines built by different manufacturers. The advantage of this approach is that it may allow for a single, one-time, permanent, hardwired physical link to be created between the machine and the single bridge controller allowing for robot integration over a factory network, creating a high level of portability of robots between machine work cells. In various embodiments, portability may be achieved through the ability to collect data as described herein and send the data through a network interface.

The universal bridge controller may use a combination of software and circuit design to be able to detect and translate incoming sensor signals from a host machine and third-party equipment such as a collaborative robot to coordinate the on-off-run-idle-wait synchronize functions of the program between the units.

In one embodiment, there may be two access ports to a controller junction box. One port may connect the controller to a collaborative robot or third-party equipment, and the other port may connect the controller junction box to a computer network. A third port may allow the hard wires emanating from the host machine to be ingressed, or connected with the I/O circuitry of the universal bridge controller. A forth port, such as a USB port, may be provided to allow for manual upload of programs to the controller.

In some embodiments, an LCD panel may display the status of certain functions during operations. The system may include one or more of the following components: a junction box containing proprietary software and circuitry; LCD display displaying system/machine status; and communication ports for linking to machine and network. In some embodiments, the universal bridge controller located between the host equipment and the collaborative program may allow for numerous I/O control ports with a wide range of voltages.

The above summary of the invention is not intended to represent each embodiment or every aspect of the present invention. Particular embodiments may include one, some, or none of the listed advantages.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a diagram of a CNC machine coupled to a collaborative robot via a universal bridge controller according to an embodiment;

FIG. 2 is a diagram providing additional details of an embodiment of a computer network;

FIG. 3 is a flowchart of a method of implementing a universal controller; and

FIG. 4 is a diagram of an embodiment of a universal controller using common codes to communicate with a CNC machine and a collaborative robot.

### DETAILED DESCRIPTION

In accordance with the present invention, systems and methods for creating and implementing a universal bridge controller for interfacing between a manufacturer's host machine and a secondary or auxiliary powered machine or robot is provided.

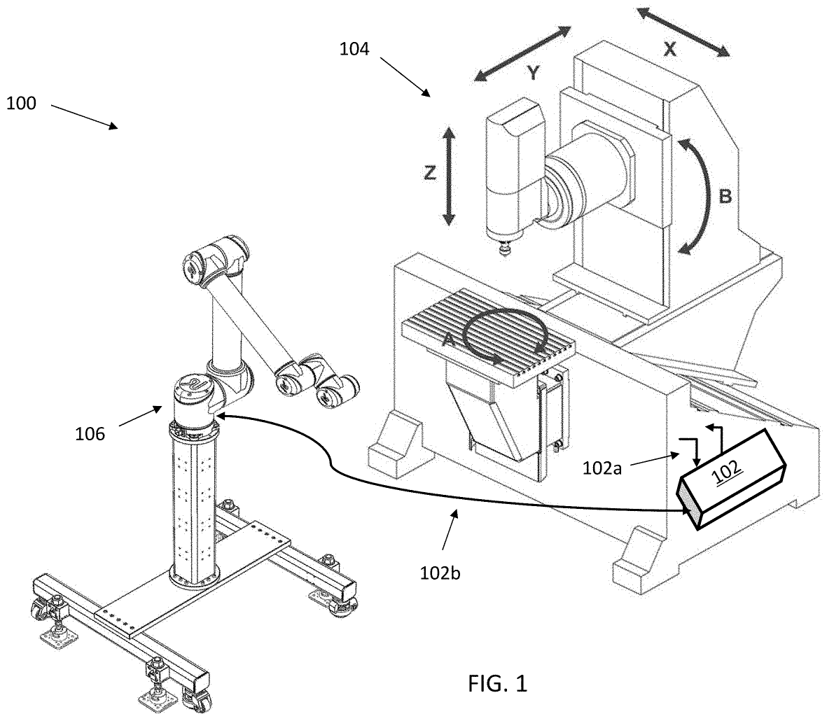

Referring now to FIG. 1, in accordance with various embodiments, a system 100 is provided having a host machine 104, a collaborative robot 106, and a machine universal bridge controller (UBC) 102. In various embodiment, the UBC 102 may establish a common GUI language/interface that allows for establishing connections to other machine controllers. The UBC 102 may allow a user to simplify programming instructions when interfacing between any combination of machines with either open and closed source (proprietary) controllers. In some embodiments, the UBC may be able to translate and communicate in multiple network machine languages including TCP/IP, Ethernet, Profinet, MODBUS, G-Code and machine assembly language. Using a common GUI language may allow mapping of each machines I/O to each other through a common and standard interface.

In various embodiments, the UBC 102 may provide for an unlimited number of I/O expansion ports to successfully connect a collaborative robot 106 or other third-party auxiliary equipment to a host machine 104. The UBC 102 may reside outside of the collaborative robot 106 and the host machine 102. By connecting, via connection 102a, and collecting most and/or all the machine 104 sensors to the external UBC 102, it is not restricted by the number of I/O it can process and/or receive. Additionally, the UBC 102 may be connected to the robot 106 through connection 102b via wireless technology and/or hardwired. In various embodiments, hardwiring may be a preferred embodiment for reliability purposes. Hardwired connection may offer better security, may reduce EMI interference due to other radio broadcasted frequencies, and may not lose WIFI connection (as is possible with wireless application) which could result in a machine fault and/or downtime. In addition to unlimited I/O ports, the UBC 102 may connect, communicate with, command, and control multiple robots to multiple machines, including the host machine through the UBC. Without the UBC, the connection would be either via a standalone configuration or just connected to one machine. This multi-machine design capability allows a single robot to be interfaced to multiple machines and operations. In this manner, a robot can be mechanized to move along a track performing incremental tasks at each station in a work cell, completing work at each station while other stations are busy completing their operations. In various embodiments, the UBCs are capable of interoperating the machine's data from various protocols (MODBUS, TCP/IP, ProfiNET, Digital 10), and then formatting the data into a standard web-based format, such as, but not limited to, JSON. Once the data is properly formatted it is uploaded to a database, which allows it to be accessed through any of the UBCs in the network. The end user may then be able to access that data by communicating with any of the UBCs over a common internet browser and any external device (smart phone, laptop, desktop), instead of having to individually go through all the protocols to access the desired data. Without the UBC, such a task would be nearly impossible because the robotics would need to be hardwired, programmed for each on-off-run-idle-wait operational state, and synchronized and prioritized with respect to the other equipment and processes. Various embodiments of the UBC allow the training and daisy-chaining of other robots and/or third-part equipment to proceed with no middleware software interface. It effectively decentralizes and decouples the machine-to-machine interface to allow for improved configurability of machines. In various embodiments, the UBCs may self-identify other UBCs in the same network by the usage of communication protocols, with ranging quality of service. In such embodiments, the UBCs may look for other UBCs by sending a broadcast signal to every IP address in the network with the same first three IP octets. All UBCs may be configured to send and respond to self-identify messages. Therefore, whenever a UBC sends a self-identify message, it will receive appropriate response signals from other UBCs in the network, then the UBC can store the location of all the other UBCs in memory for further use.

Several UBCs can exist within a factory on the same network. The networked UBCs, connected via Ethernet connections for example, may be able to self-identify IP Addresses and ports for communicating among each other on the network. Demonstrated through the use of a UDP broadcast (UDP is a low level network protocol that has no quality of service (requires no response that facilitates the likelihood of successful delivery of message)) that steps through the network's IP address list by changing the broadcast counter from “192.0.0.X” where X is stepped through 1-255. The “192.0.0” is configured by the customer once. The UBCs are configured to respond to another UBC's UDP broadcast. The IP addresses that perform the appropriate response, the other UBCs, may then be stored in memory for further use. Data may be openly shared among the UBC devices and/or establishing a master/slave configuration. This initiates a model of communication where one device has unidirectional control over one or more devices as well as establishing a hierarchy for a back-up master replacement system in the case of a fault or removal. The UBC's may act as nodes in a radio-frequency network, sharing all data and configuration information. This enables for any node to be removed from the system without damage to the rest of the network. Just like the slave nodes, when the master node is removed/configured, the other nodes make up for the difference by reconfiguring the system and reestablishing the hierarchy. The purpose of the redundancy of the UBC network is to allow for distributed data collection and storage over the entire network, not requiring the end user to access a specific terminal, but instead allows access to the data through any one of the UBCs over a common internet browser and any external device (smart phone, laptop, desktop).

The common interface may allow the UBC to take control of both machines' movement prioritization with a sequence synchronization architecture between each machine. In other words, it may coordinate and control the on-off-run-idle-wait operational state of each machine. Using a UBC, the internal memory of the controller can read the current state of the machine and cache the last known state. This event is often important because many events are triggered by what is known as an M-Code (an industry standard machine output). But many legacy machines do not generate the necessary M-codes to trigger an event to coordinate/synchronize activity with an external piece of equipment. Thus, the UBC may also be designed with object-based trigger functionality and codes that detect and relay states and/or relay event over to the digital I/O. This is not able to be achieved without having the processing power and code recognition ability of a UBC.

In various embodiments, the UBC may include a technique for establishing the portability of a collaborative robot or other auxiliary third-party equipment whether used in automated or non-automated applications. This may allow the robot to be deployed at any station at any time depending on the manufacturing demand. This may also allow a robot to be programmed once and then changed and/or moved to multiple locations with minimal interruption to productivity. In addition, it may allow greater flexibility in that the robots may not need to be tied to a single machine, but may be moved to various locations. In various embodiments, the UBCs may interface to a machine, interoperate the machine's data from various protocols (MODBUS, TCP/IP, ProfiNET, Digital 10), package the data into a standard web-based language, and send it over a network specifically to allow the integrated robots to be decoupled from the work cells.

In various embodiments, the UBC may establish a common network interface (e.g., Internet of Things—IoT without necessarily being connected to the Internet) which may allow for both the controller of the host machine and auxiliary machine to be simultaneously connected to and accessed by a company's information technology (IT) network. The ability for the controller to run on an internal IT network allows for several benefits to be realized over other direct tethered configurations. Specifically, this may allow for a more secure operation. Once the connection to the IT network is established, the equipment operational status can be published to an internal operational dashboard visible to the operations team within the network in order to monitor operational status of both the host machine as well as the collaborative robot (or third-party) machine. Further, the dashboard may allow remote access to both the host and auxiliary machine through a variety of both mobile and fixed display platforms. This allows the control and function to be accessed from any terminal from anywhere in the company by either the management or manufacturing executives. The operational configuration of the host machine and robot or third-party equipment may be reported to the dashboard. Such a configuration may allow the downloading of machine-collaborative robot master program and subroutine from company servers at any location. In various embodiments, security and access may be controlled from the controller. In various embodiments, the programming may reside on the controller. In some embodiments, special collaborative robotic applications (CAPS) may be uploaded through the internal network or from USB ports. Various configurations may decouple the requirement that the programming has to be uploaded from a USB device and/or programmed at the machine and stored in volatile memory.

In some embodiments, one or more RJ45 outputs may be connected from the controller to the collaborative robot or a wireless connection, the machine and collaborative robot can be tethered and un-tethered depending on the manufacturing needs of the company. In various embodiments, a collaborative robot (or other third-party equipment) is not required to be tied to any one machine, power source, or Ethernet connection. The UBC may allow the configuration to be offloaded so functionality is controller centric and not peripheral (machine, robot, accessories) centric. If the auxiliary robot or machine goes offline due to a fault, for preventive maintenance, or to be used elsewhere, the robot or machine only needs to be disconnected and moved to the next location. In various embodiments where the connection between the host machine and UBC 102 is hardwired, the single wire connection allows the auxiliary machine to be freely moved or replaced. Once a new or replacement auxiliary machine is reconnected to the bridge controller, it is recognized on the IT network and the necessary programs and network links are re-established among the various components of the system. All the necessary programs and instruction sets are automatically downloaded into the bridge controller and operations can begin without delay. In various embodiments, the controller is able to download software from a centralized server to allow for target machine flexibility. In other words, a collaborative robot may be moved from machine-to-machine, for example from a 3-axis machine to a 5-axis machine, depending on where the robot is needed. The programs specific to each different machine can be downloaded to the controller as needed.

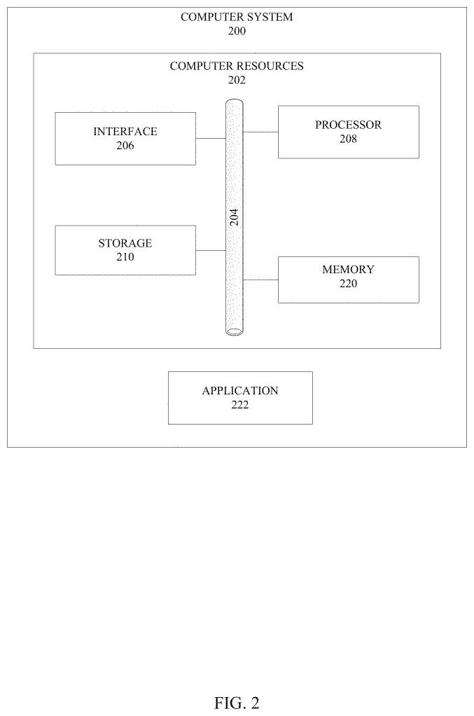

Referring now to FIG. 2, a diagram of a computer system 200 for implementing and connecting the UBC to a CNC machine, a collaborative robot, and/other computers is provided. The components of the computer system 200 may comprise any suitable physical form, configuration, number, type and/or layout. As an example, and not by way of limitation, the computer system 200 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 200 may include one or more computer systems; be unitary or distributed; span multiple locations; span multiple machines; or reside in a cloud, which may include one or more cloud components in one or more networks.

In the depicted embodiment, the computer system 200 includes a processor 208, memory 220, storage 210, interface 206, and bus 204. Although a particular computer system is depicted having a particular number of particular components in a particular arrangement, this disclosure contemplates any suitable computer system having any suitable number of any suitable components in any suitable arrangement.

Processor 208 may be a microprocessor, controller, or any other suitable computing device, resource, or combination of hardware, software and/or encoded logic operable to execute, either alone or in conjunction with other components, (e.g., memory 220), the application 222. Such functionality may include providing various features discussed herein. In particular embodiments, processor 208 may include hardware for executing instructions, such as those making up the application 222. As an example and not by way of limitation, to execute instructions, processor 208 may retrieve (or fetch) instructions from an internal register, an internal cache, memory 220, or storage 210; decode and execute them; and then write one or more results to an internal register, an internal cache, memory 220, or storage 210.

In particular embodiments, processor 208 may include one or more internal caches for data, instructions, or addresses. This disclosure contemplates processor 208 including any suitable number of any suitable internal caches, where appropriate. As an example and not by way of limitation, processor 208 may include one or more instruction caches, one or more data caches, and one or more translation lookaside buffers (TLBs). Instructions in the instruction caches may be copies of instructions in memory 220 or storage 210 and the instruction caches may speed up retrieval of those instructions by processor 208. Data in the data caches may be copies of data in memory 220 or storage 210 for instructions executing at processor 208 to operate on; the results of previous instructions executed at processor 208 for access by subsequent instructions executing at processor 208, or for writing to memory 220, or storage 210; or other suitable data. The data caches may speed up read or write operations by processor 208. The TLBs may speed up virtual-address translations for processor 208. In particular embodiments, processor 208 may include one or more internal registers for data, instructions, or addresses. Depending on the embodiment, processor 208 may include any suitable number of any suitable internal registers, where appropriate. Where appropriate, processor 208 may include one or more arithmetic logic units (ALUs); be a multi-core processor; include one or more processors 208; or any other suitable processor.

Memory 220 may be any form of volatile or non-volatile memory including, without limitation, magnetic media, optical media, random access memory (RAM), read-only memory (ROM), flash memory, removable media, or any other suitable local or remote memory component or components. In particular embodiments, memory 220 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 220 may include one or more memories 220, where appropriate. Memory 220 may store any suitable data or information utilized by the computer system 200, including software embedded in a computer readable medium, and/or encoded logic incorporated in hardware or otherwise stored (e.g., firmware). In particular embodiments, memory 220 may include main memory for storing instructions for processor 208 to execute or data for processor 208 to operate on. In particular embodiments, one or more memory management units (MMUs) may reside between processor 208 and memory 220 and facilitate accesses to memory 220 requested by processor 208.

As an example and not by way of limitation, the computer system 200 may load instructions from storage 210 or another source (such as, for example, another computer system) to memory 220. Processor 208 may then load the instructions from memory 220 to an internal register or internal cache. To execute the instructions, processor 208 may retrieve the instructions from the internal register or internal cache and decode them. During or after execution of the instructions, processor 208 may write one or more results (which may be intermediate or final results) to the internal register or internal cache. Processor 208 may then write one or more of those results to memory 220. In particular embodiments, processor 208 may execute only instructions in one or more internal registers or internal caches or in memory 220 (as opposed to storage 210 or elsewhere) and may operate only on data in one or more internal registers or internal caches or in memory 220 (as opposed to storage 210 or elsewhere).

In particular embodiments, storage 210 may include mass storage for data or instructions. As an example and not by way of limitation, storage 210 may include a hard disk drive (HDD), a floppy disk drive, flash memory, an optical disc, a magneto-optical disc, magnetic tape, or a Universal Serial Bus (USB) drive or a combination of two or more of these. Storage 210 may include removable or non-removable (or fixed) media, where appropriate. Storage 210 may be internal or external to the computer system 200, where appropriate. In particular embodiments, storage 210 may be non-volatile, solid-state memory. In particular embodiments, storage 210 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 210 may take any suitable physical form and may comprise any suitable number or type of storage. Storage 210 may include one or more storage control units facilitating communication between processor 208 and storage 210, where appropriate.

In particular embodiments, interface 206 may include hardware, encoded software, or both providing one or more interfaces for communication (such as, for example, packet-based communication) among any networks, any network devices, and/or any other computer systems. As an example and not by way of limitation, communication interface 206 may include a network interface controller (NIC) or network adapter for communicating with an Ethernet or other wire-based network and/or a wireless NIC (WNIC) or wireless adapter for communicating with a wireless network.

Depending on the embodiment, interface 206 may be any type of interface suitable for any type of network for which computer system 200 is used. As an example and not by way of limitation, computer system 200 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 200 may include any suitable interface 206 for any one or more of these networks, where appropriate.

In some embodiments, interface 206 may include one or more interfaces for one or more I/O devices. One or more of these I/O devices may enable communication between a person and the computer system 200. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 206 for them. Where appropriate, interface 206 may include one or more drivers enabling processor 208 to drive one or more of these I/O devices. Interface 206 may include one or more interfaces 206, where appropriate.

Bus 204 may include any combination of hardware, software embedded in a computer readable medium, and/or encoded logic incorporated in hardware or otherwise stored (e.g., firmware) to couple components of the computer system 200 to each other. As an example and not by way of limitation, bus 204 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 204 may include any number, type, and/or configuration of buses 204, where appropriate. In particular embodiments, one or more buses 204 (which may each include an address bus and a data bus) may couple processor 208 to memory 220. Bus 204 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 208 (such as, for example, one or more internal registers or caches), one or more portions of memory 220, one or more portions of storage 210, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more APIs stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

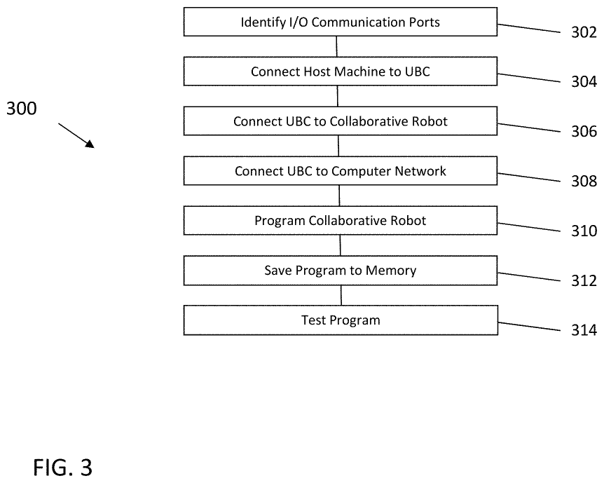

Referring now to FIG. 3, an embodiment of a method 300 of implementing and using a universal bridge controller (UBC) is provided. At step 302, a user identifies and locates the required digital and analog I/O communication ports on the host machine that control key manufacturing operations. At step 304, a user connects the host machine I/O communications ports from the host machine to the I/O ports of the UBC. At step 306, a user connects the UBC to the collaborative robot using a single, standard communications cable, such as, for example, RJ45, HDMI, or other connection sized to accommodate the necessary amount of I/O links. At step 308, a user connects the UBC to a computer network. At step 310, a user programs the collaborative robot steps (or third-party auxiliary equipment) to automate the operation sequence including the necessary on-off-run-idle-wait synchronize functions. At step 312, a user saves the program to on-board memory cache and network storage drives. At step 314, a user tests the program and adjust as necessary.

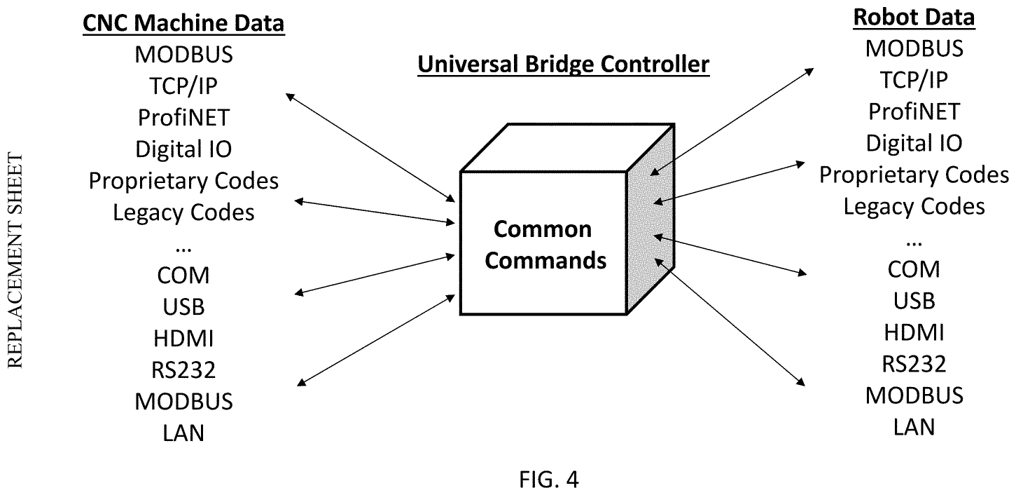

Referring now to FIG. 4, a diagram of a UBC coupled between a CNC machine and a collaborative robot is shown. As stated above, a CNC machine may output data in a format, such as FANUC, Haas Next Gen, or other protocol, that is not compatible with a collaborative robot. By coupling the CNC machine to the UBC, the data from the CNC machine is translated into a common set of commands that may then be translated into a format compatible with the collaborative robot.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit and scope of the invention.

What is claimed is:

1. A system for interfacing CNC machines to collaborative robots wherein at least one of the CNC machines cannot communicate directly with at least one of the collaborative robots, the system comprising:
a CNC machine programmed to run a machine process, wherein the CNC machine produces a first signal when a first subroutine finishes and then waits to receive a second signal before continuing;
a collaborative robot programmed to tend the CNC machine, wherein the collaborative robot begins a tending process when the first subroutine finishes;
a universal bridge controller communicatively coupled to the CNC machine via a first data connection and communicatively coupled to the collaborative robot via a second data connection, the universal bridge configured to translate data received from the CNC machine using a first communication protocol into data understandable by the collaborative robot and translate data received from the collaborative robot using a second communication protocol into data understandable by the CNC machine; and
wherein the universal bridge controller is configured to receive the first signal from the CNC machine, translate the first signal into a corresponding common command, translate the common command into a corresponding code understandable by the collaborative robot, and transmit the code to the collaborative robot to indicate to the collaborative robot to being the tending process.

2. The system of claim 1, wherein the universal bridge controller is coupled to the CNC machine via a data bus.

3. The system of claim 2, wherein the data bus is selected from the group consisting of an ISA bus, a PCI bus, a VME bus, a universal-serial-bus (USB), and an Ethernet connection.

4. The system of claim 1, wherein the first data connection is different than the second data connection.

5. The system of claim 4, wherein the first data connection is wired directly to a circuit board on the CNC machine.

6. The system of claim 1, wherein the first communication protocol is different than the second communication protocol.

7. The system of claim 6, wherein the first communication protocol is selected from the group consisting of a MODBUS, TCP/IP, ProfiNET, and Digital IO.

8. The system of claim 6, wherein the second communication protocol is a standard web-based language.

9. A method of interconnecting a CNC machine and an industrial robot, the method comprising:
providing a universal bridge controller configured to receive operational state information in a first format and translate the operational state information into a second format;
coupling the universal bridge controller to a CNC machine via a first data connection and to an industrial robot via a second data connection;
receiving at the universal bridge controller via a first data connection, data in the first format corresponding to a first operational state of the CNC machine;
translating, at the universal bridge controller, the first operational state received from the CNC machine into the second format;
transmitting the first operational state in the second format to the industrial robot via the second data connection;
receiving at the universal bridge controller via the second data connection, data in the second format corresponding to a second operational state of the industrial robot;
translating, at the universal bridge controller, the second operational state received from the industrial robot into the first format; and
transmitting the second operational state in the first format to the CNC machine via the first data connection.

10. The method of claim 9, wherein the CNC machine and the industrial robot cannot communicate directly.

11. The method of claim 9, and further comprising running a test routine on the CNC machine to determine the operational state information.

12. The method of claim 9, and further comprising running a test routine on the CNC machine to determine the first format.

13. A method of interfacing a CNC machine and a collaborative robot, the method comprising:
coupling a universal bridge controller to a CNC machine, the universal bridge controller being capable of translating data from a plurality of data protocols;
receiving data in a first format from the CNC machine;
processing the received data with the universal bridge controller to generate a first set of common commands;
processing the first set of common commands with the universal bridge controller to generate a first set of robot codes;
providing the first set of robot codes to a collaborative robot to indicate to the collaborative robot to begin a first process;
receiving an indication from the collaborative robot that the first process is finished, wherein the received data includes a second set of robot codes;
processing the second set of robot codes with the universal bridge controller to generate a second set of common commands;
processing the second set of common commands with the universal bridge controller to generate a second set of G-codes; and
providing the second set of G-codes to the CNC machine to indicate to the CNC machine to begin a second process.
